(19) United States
(12) Patent Application Publication
(10) Pub. No.: US 2014/0016981 A1
(43) Pub. Date: Jan. 16, 2014

(54) DISPENSING VIAL

(71) Applicant: Jonathan B. Levine, New York, NY (US)

(72) Inventor: Jonathan B. Levine, New York, NY (US)

(21) Appl. No.: 13/546,479

(22) Filed: Jul. 11, 2012

(51) Int. Cl. A61C 17/00; B05C 17/005

(52) U.S. Cl. 401/28; 401/134

(57) ABSTRACT

A container has a sealed chamber. An applicator mounted on the container has a passageway and a comb-like applicator having a central opening that allows flow of a gel through its plural teeth. A cap is mounted over the applicator member and carries a piercing element. A limit stop limits the downward movement of the cap. The limit stop is attached to the applicator member by a frangible coupling. The limit stop can be broken off the applicator, whereupon the cap may be pushed downward so the piercing element pierces the foil seal. Thereafter, the flexible container may be squeezed to dispense the gel. The tip of the applicator is designed to target the gel to the teeth, avoiding the lips and the gums and avoiding irritation and preventing contact with sensitive areas.

### BACKGROUND OF THE INVENTION

The present invention relates to a dispensing vial. The preferred environment of use of the present invention is in the dispensing of tooth whitening substances on the teeth of a user. However, the inventive vial may also be used in any other environment in which a substance must be stored in a hermetically sealed environment and dispensed when desired in an accurate and efficient manner.

Applicant is also the inventor in Published Application Nos. US 2010/0240013, published Sep. 23, 2010, and US 2011/0183296, published Jul. 28, 2011. These published applications disclose dispensing devices including a container in which a substance is stored, a cap sealing the container, and structure permitting removal of the cap to dispense the substance within the container. In each of these earlier published applications, the cap includes structure providing the sealing function. The present invention differs from the teachings of these earlier published applications in several respects. First, the present invention does not solely rely upon a cap to seal the contents of a container. Rather, a sealing element such as, for example, a foil seal is adhered across the opening of the container to seal its contents. Furthermore, as compared to the earlier published applications, the present invention includes a limit stop element that precludes movement of the inventive cap toward the foil seal to pierce it until the limit stop element is removed.

Furthermore, an additional distinction between the present invention and the inventions disclosed in Applicant's earlier published applications consists of a piercing element incorporated into the cap which may be employed to pierce the foil seal. However, the cap may not be reciprocated downwardly to cause the piercing element to pierce the foil seal until the limit stop element is removed.

Another difference between the teachings of the present invention and those of Applicant's earlier published applications consists of the ability of the cap to seal the opening in the container once the piercing element has pierced the foil seal. The present invention is also devoid of any valve as the foil seal hermetically seals the contents of the container and the piercing element pierces the foil seal to facilitate access to the contents.

In another distinction, in the applicator disclosed in US 2011/0183296, the applicator tip is oval-shaped with the ends of the fingers defining an oval disposed at an oblique angle to the longitudinal axis of the applicator tip. The tip of the present invention consists of two rows of fingers. The rows are slightly arcuate with fingers of each row having equal lengths but one row having longer fingers than the other.

In another distinction, the applicator tip tapers toward its end allowing for a more targeted placement of the formulation to the teeth, avoiding lips and gums to prevent irritation and sensitivity.

Accordingly, the present invention distinguishes from the teachings of Applicant's earlier published applications.

### SUMMARY OF THE INVENTION

The present invention relates to a dispensing vial. The present invention includes the following interrelated objects, aspects and features:
(1) In a first aspect, the present invention contemplates a container having two arcuate gripping members to each side of a central chamber. The central chamber is closed at the bottom and has an upwardly facing opening.
(2) The upwardly facing opening has an applicator member mounted thereon. The applicator member has a passageway connected to the opening of the container and a comb-like applicator structure having a central opening that allows flow of the substance previously stored within the chamber of the container with the applicator member having a plurality of teeth which facilitate applying the substance from the container in a manner as desired. The applicator member also includes a limit stop element for a purpose to be described hereinafter.
(3) A cap is removably placed over the applicator member. The cap includes internal structure meshing with external structure on the applicator member to hold the cap in place when the inventive vial has not been used.
(4) The cap has mounted therein a piercing element or pintel that extends downwardly from its location of mounting. The opening of the container is preferably covered by a foil seal that facilitates hermetic sealing of the contents contained within the chamber of the container.
(5) The limit stop element limits the downward movement of the cap in such a manner that the end of the piercing element is spaced above the foil seal so long as the limit stop element is in place. The limit stop element is attached to the applicator member by a frangible coupling permitting the limit stop element to be twisted or otherwise manipulated to break it off the applicator member. Once the limit stop element has been removed from the applicator member, the cap may be pushed downward so that the piercing element pierces the foil seal. In that position, the structure of the cap provides a peripheral seal still sealing the contents of the container. When it is desired to dispense the contents of the container, the cap is pulled upward and removed from the applicator member, whereupon the container, which is made of a flexible resilient material, may be squeezed to cause the substance within the chamber of the container to be forced out through the opening where the foil seal previously sealed, into the comb-like applicator structure of the applicator member, and thence between the teeth of the applicator member to be dispensed.

Accordingly, it is a first object of the present invention to provide a dispensing vial.

It is a further object of the present invention to provide such a vial in which a substance to be dispensed is hermetically sealed within a chamber of a container using a sealing element such as a foil seal.

It is a still further object of the present invention to provide such a vial in which a cap overlies an applicator member with the cap including a piercing element.

It is a still further object of the present invention to provide such a vial in which a limit stop element precludes the piercing element of the cap from piercing the foil seal unless the limit stop element is removed.

It is a still further object of the present invention to provide such a vial in which the piercing element is attached to the applicator member with a frangible coupling allowing the limit stop element to be removed from the applicator member.

It is a yet further object of the present invention to provide such a vial which permits the piercing element of the cap to pierce the foil seal of the container once the limit stop element has been removed.

These and other objects, aspects and features of the present invention will be better understood from the following detailed description of the preferred embodiment when read in conjunction with the appended drawing figures.

### BRIEF DESCRIPTION OF THE DRAWINGS

FIG. 1 shows a perspective view of the present invention with portions of the applicator member shown in phantom.

FIG. 2 shows a front view of the container of the present invention.

FIG. 3 shows a side view of the container of the present invention.

FIG. 4 shows a cross-sectional view along the line 4-4 of FIG. 3.

FIG. 5 shows a cross-sectional view along the line 5-5 of FIG. 2.

FIG. 6 shows a longitudinal cross-sectional view through the entire dispensing vial.

FIG. 7 shows a cross-sectional view along the line 7-7 of FIG. 6.

FIG. 8 shows an enlarged view of a portion of FIG. 6.

FIG. 9 shows an enlarged view of a portion of FIG. 7.

FIG. 10 shows a cross-sectional view through the cap of the present invention from the same orientation as in FIG. 6.

FIG. 11 shows an enlarged cross-sectional view through the cap from the same orientation as FIG. 7.

FIG. 12 shows a front view of the applicator member of the present invention.

FIG. 13 shows a side view of the applicator member.

FIG. 14 shows a top view of the applicator member.

FIG. 15 shows a view from the other side of the applicator member with respect to the view of FIG. 13.

FIG. 16 shows a perspective view of the container showing the foil seal.

FIG. 17 shows a schematic view of the inventive dispensing vial with the foil seal intact.

FIG. 18 shows a view of the dispensing vial with the limit stop element removed, and the piercing element of the cap having pierced the foil seal.

FIG. 19 shows a view of the dispensing vial with the cap removed and the substance within the chamber of the container dispensed to the applicator member's comb-like applicator structure.

### SPECIFIC DESCRIPTION OF THE PREFERRED EMBODIMENT

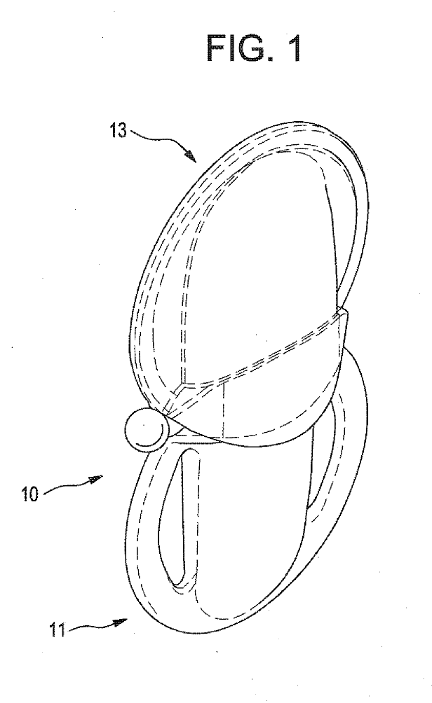

With reference to FIG. 1, the present invention is generally designated by the reference numeral 10 and includes a container 11, a cap 13, and an applicator member better seen with reference to FIGS. 12-15 and generally designated by the reference numeral 15.

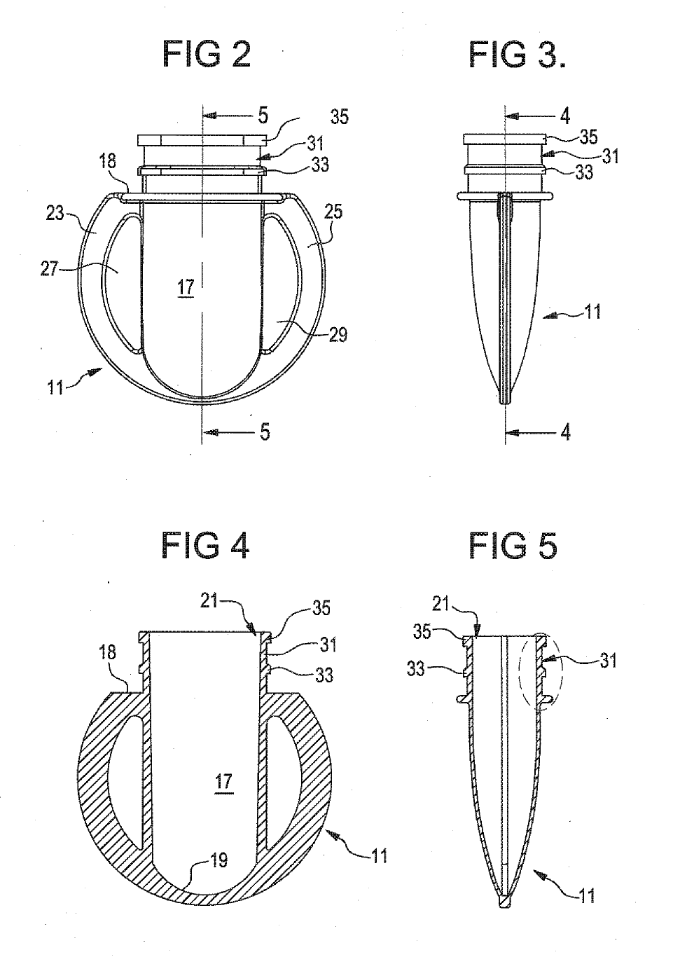

With reference to FIGS. 2-5, the container 11 includes a central chamber 17 that has a closed bottom 19 and an upwardly facing opening 21. The chamber 17 is designed to receive a quantity of a substance to be dispensed from the container 11. That substance may comprise a tooth whitening gel, paste or liquid, a substance for treating bacteria in the oral cavity, or any other liquid, gel or paste. As seen in FIG. 2, the container 11 has gripping handles 23 and 25 that are arcuate in nature and define openings 27 and 29 between the handles 23 and 25, respectively, and the chamber 17.

As seen in particular in FIGS. 2 and 5, the opening 21 is defined at the top of a neck 31 that has a pair of annular protrusions 33 and 35 extending radially outwardly therefrom, for a purpose to be described in greater detail hereinafter.

In the preferred embodiment, with reference to FIG. 16, the opening 21 is sealed by a frangible foil seal 22 that facilitates hermetic sealing of the chamber 17 including any substance stored therein. The hermetic sealing may also include vacuum packing.

As seen in FIGS. 2 and 4 in particular, the container 11 has a shoulder 18 extending around the neck 31 for a purpose to be described in greater detail hereinafter.

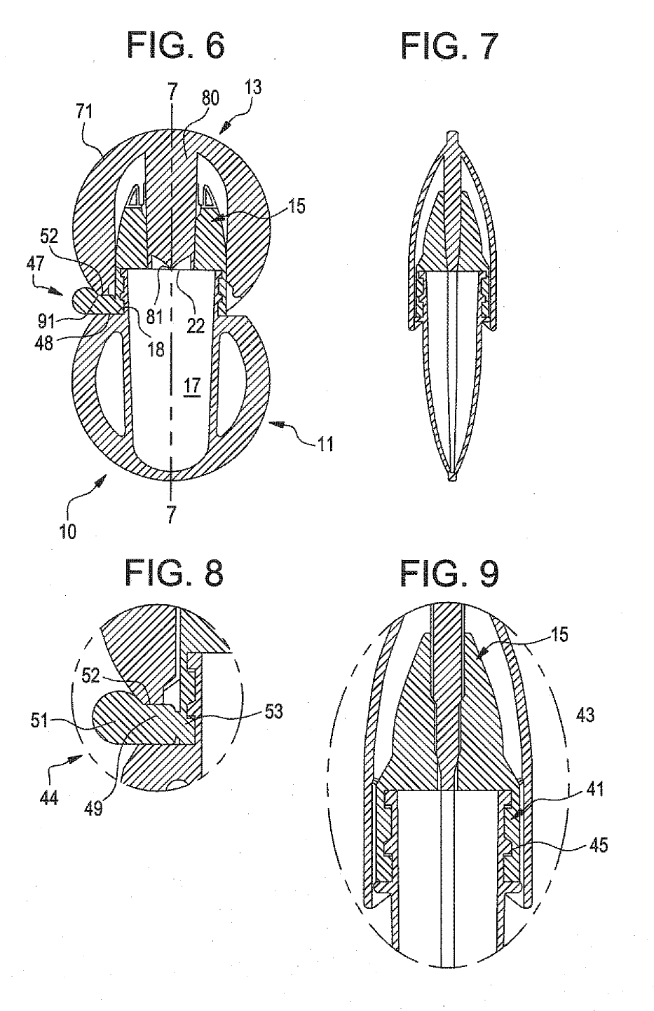

Reference is now made to FIGS. 6-9 and 12-15 which show details of the applicator member 15. With reference to FIG. 9, it is seen that the applicator member 15 includes a sleeve-like portion 41 that includes recesses 43 and 45 that fit over the annular protrusions 35 and 33, respectively, to fasten the applicator 15 onto the container 11. In the preferred embodiment, the applicator 15 is made of a resilient material that allows it to be pushed down over the neck 31 of the container 11 to fasten the applicator member 15 in the orientation best seen in FIG. 9.

With particular reference to FIGS. 6, 8, 12 and 14, the applicator member 15 has attached thereto a limit stop element 47 having a narrow neck 49, a bulbous end 51, and an attachment 53 which is extremely thin and in the nature of a frangible element. As clearly seen in FIG. 6, the limit stop element 47 has a lower surface 48 that sits on the shoulder 18 of the container 11 when the applicator 15 is installed thereon. The limit stop element 47 also includes an upper surface 52 for a purpose to be described in greater detail hereinafter.

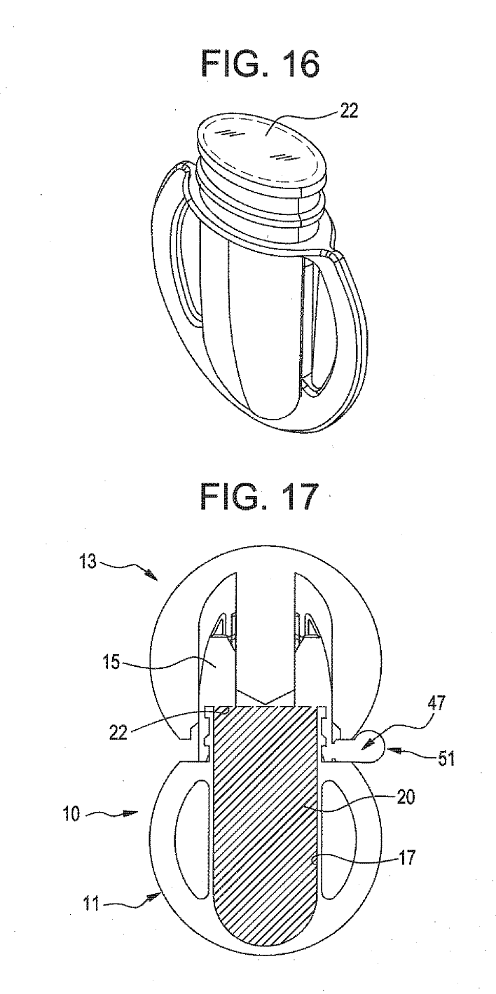

With further reference to FIGS. 12-15, the applicator member 15 includes a comb-like applicator structure 57. As seen in FIGS. 12-15, the comb-like applicator structure 57 includes two rows 59 and 61 of teeth 63 that include spaces 65 therebetween and surround a passageway 64 (FIG. 14) extending through the applicator member. As shown in FIGS. 13 and 15, the row 61 of teeth 63 extends upward slightly further than the row 59 of teeth 63. This is done because, typically, the user will hold the dispensing vial 10 at a slight angle with respect to the surface on which a substance is being applied. The differing heights of the rows 59 and 61 accounts for this eventual manner of use and assures that the substance being applied will be smoothly applied on the surface to which it is being applied. Of course, if desired, a differing relationship between the rows 59 and 61 of teeth 63 may be employed.

As clearly shown in FIG. 14, the rows 59, 61 of teeth are arcuate from above, diverging away from one another centrally. Applicant has found that the combination of this arcuate structure and the vertical staggering of the rows 59, 61 (FIGS. 13 and 15) is effective to hold viscous whitening gel within the teeth of the applicator structure while deterring gel movement outside those teeth. This configuration also best facilitates holding the vial sideways at an angle to coat teeth in a single sweeping motion from one side of the mouth to the other side thereof. The curvature of the rows 59, 61 of teeth causes them to act as a “lip bumper” which deters coating the lips with the gel. This is far superior to and more efficient than devices designed to “paint” gel on teeth one at a time. In whitening teeth, it is imperative that the whitening gel be coated on the teeth as simultaneously as possible. This is because, when the gel is exposed to air, oxidation begins. Tooth whitening procedures are timed, so the user wants their teeth all whitened to the same degree at each application. Thus, providing an applicator that can start the whitening process substantially simultaneously for all the teeth is quite advantageous. This is also true for whitening procedures that employ a mouthpiece placed over the teeth after they have been coated with whitening gel. The tip of the applicator that has the comb-like structure to hold the viscous thixotropic gel (gel stays where you put it) is tapered toward its end allowing for a targeted placement of gel.

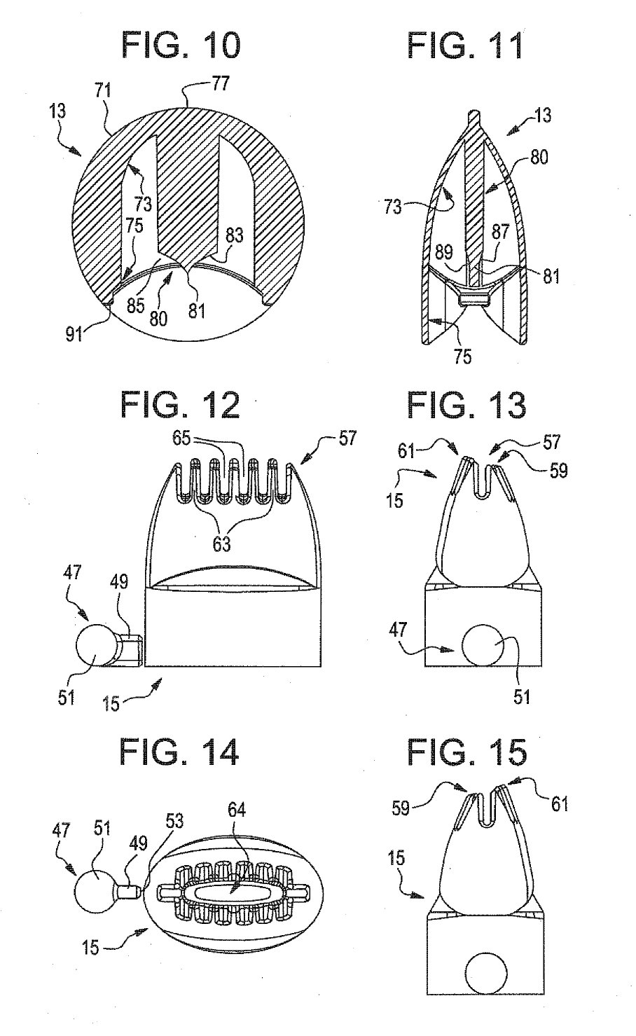

With reference, now, to FIGS. 6, 10 and 11 in particular, the cap 13 is seen to include a generally arcuate top surface 71 and an interior cavity 73 that is downwardly open at 75. As seen by comparing FIGS. 10 and 11, the cap 13 is wide in one direction (FIG. 10) and relatively narrow in a direction perpendicular to the direction shown in FIG. 10 (FIG. 11). The cap 13 has a top location at 77. Downwardly depending from the top 77 of the cap 13 within the interior cavity 73 is a piercing element or pintel 80. As seen by comparing FIGS. 10 and 11, this pintel 80 is relatively flat and has a pointed end 81 with generally arcuate walls 83 and 85 extending proximally from the pointed end 81. In FIG. 11, it is seen that additional walls 87 and 89 also extend proximally from the pointed end 81 such that from the pointed end 81 in the proximal direction, the pintel 80 has four sides.

With reference to FIG. 10, it is seen that the cap 13 has a lower shoulder 91. With reference to FIG. 6, the shoulder 91 sits on the surface 52 of the limit stop element when the dispensing vial 10 is assembled together as shown in FIGS. 1 and 6, for example. Thus, as also seen in FIG. 6, the pointed end 81 of the piercing element or pintel 80 is suspended above the foil seal 22 hermetically sealing the chamber 17 of the container 11. Thus, so long as the limit stop element 47 is assembled to the applicator 15, as shown in FIGS. 1 and 6 for example, the cap 13 cannot be pushed downwardly in the view of FIGS. 1 and 6 to pierce the frangible foil seal 22.

When it is desired to dispense the substance contained within the chamber 17, the user must first remove the limit stop element 47 from the applicator 15. To do so, the bulbous end 51 of the limit stop element is grasped by the user and is twisted and pulled until it breaks off at the frangible portion 53 and may be removed from the applicator 15. Once this occurs, there is no impediment to the cap 13 being pushed downward so that the piercing element or pintel 80 may have its pointed end 81 pierce the frangible foil seal 22 to unseal the chamber 17.

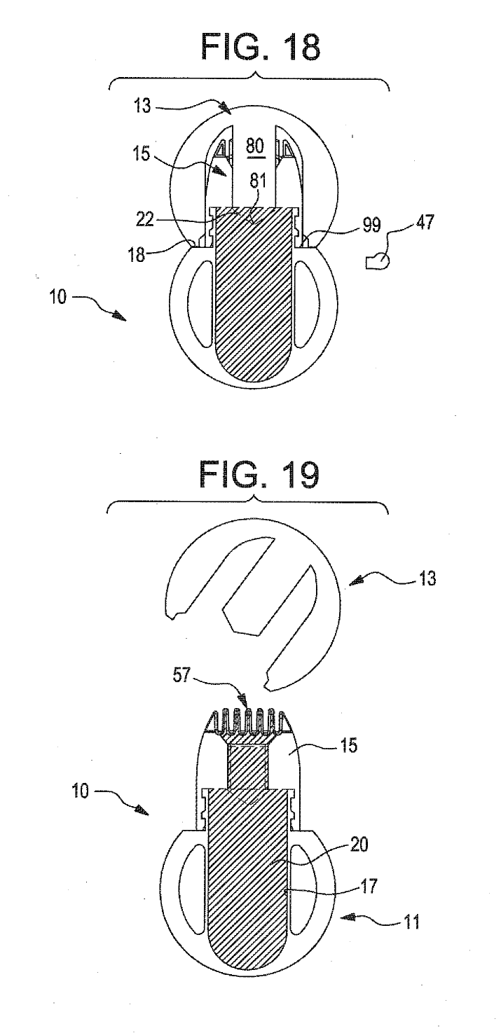

With reference, now, to FIGS. 1 and 16-19, an explanation of the operation of the present invention will now be provided. With the dispensing vial 10 in the configuration shown in FIG. 1, and with the foil seal 22 in place as shown in FIG. 16, the status of the substance 20 contained within the chamber 17 is that the foil seal 22 is intact and the chamber 17 hermetically retains the substance 20. With reference to FIG. 18, in the manner explained above, the bulbous end 51 of the limit stop element 47 is grasped and torn off the applicator 15. This is depicted in FIG. 18 which shows the limit stop element 47 removed from the applicator 15. Thereupon, as shown in FIG. 18, the cap 13 may be pushed down, reciprocating so that the pointed end 81 of the pintel 80 pierces the foil seal 22, thereby creating an opening. Thereafter, the cap 13 may be removed as shown in FIG. 19, and the container 11 which is made of a flexible, resilient material, may be squeezed to cause the substance 20 to be pushed upwardly through the applicator 15 and into the area of the comb-like applicator structure 57 as shown in FIG. 19 where the comb-like applicator structure 57 may be used to apply the substance 20 at the desired location. In use, the user can smile, exposing their teeth, and the applicator can be moved side to side in a sweeping motion to coat the teeth with gel while avoiding coating the lips. Thereafter, the user can, if desired, place a mouthpiece in their mouth, covering the teeth and sealing the gel inside the mouthpiece for most efficient whitening.

If all of the substance 20 is not used on a first application, the cap 13 may be restored to the configuration shown in FIG. 18 where an elastomeric seal 99 engages the shoulder 18 to seal the contents of the chamber 17. Once the substance 20 has been exhausted from the chamber 17, the inventive dispensing vial 20 may be suitably discarded.

In the preferred embodiment of the present invention, the container 11 is made of any flexible, resilient material that will facilitate squeezing the container 11 to dispense the contents 20 from the chamber 17 including soft plastic or natural or synthetic rubber. If desired, the applicator 15 may be made of a hard plastic or other relatively non-resilient material. The same or similar material may be used in manufacturing the cap 13. The substance 20 may be a tooth whitening gel, paste or liquid, an anti-bacterial agent or any other substance that can be dispensed from a container.

The present invention provides an extremely simple, aesthetically attractive dispensing vial that allows hermetic sealing of the contents of a chamber in a safe and effective manner until it is desired to dispense that substance. The manner of accessing the substance 20 within the chamber 17 is efficient, easy to do, and effective.

As such, an invention has been disclosed in terms of a preferred embodiment thereof which fulfills each and every one of the objects of the invention as set forth hereinabove, and provides a new and useful dispensing vial of great novelty and utility.

Of course, various changes, modifications and alterations in the teachings of the present invention may be contemplated by those skilled in the art without departing from the intended spirit and scope thereof.

As such, it is intended that the present invention only be limited by the terms of the appended claims.

1. An improved dispensing vial, comprising:
a) a container having an internal chamber and an outlet, said outlet being sealed by a frangible sealing element;
b) an applicator mounted above said outlet and including a central passageway terminating remote from said container at a comb-like applicator structure;
c) a cap mounted over said applicator, said cap having a piercing member extending toward said frangible sealing element, said cap being movable between a first position in which said piercing member is spaced from said frangible sealing element and a second position in which said piercing member pierces said frangible sealing element; and
d) a limit stop having a first position in which said piercing member is precluded from piercing said frangible sealing element and a second position in which said cap is permitted to move to said second position of said cap to cause said piercing member to pierce said frangible sealing element.

2. The vial of claim 1, wherein said outlet is at an end of an elongated neck.

3. The vial of claim 1, wherein said container is resilient, whereby it may be squeezed and compressed to dispense a substance stored in said chamber.

4. The vial of claim 1, wherein said frangible sealing element comprises a foil seal.

5. The vial of claim 1, wherein said limit stop is connected to said applicator.

6. The vial of claim 5, wherein said limit stop has a top surface, said cap having a bottom surface resting on said top surface of said limit stop in said first position of said limit stop.

7. The vial of claim 6, wherein said second position of said limit stop comprises said limit stop being removed from said applicator.

8. The vial of claim 7, wherein in said first position of said limit stop, said limit stop is attached to said applicator via a frangible element.

9. The vial of claim 1, wherein movement of said cap from said first position to said second position comprises reciprocation.

10. The vial of claim 1, wherein said applicator structure comprises two rows of teeth to either side of said central passageway, said rows of teeth being arcuate and diverging from one another.

11. The vial of claim 10, wherein one row of teeth has longer teeth than the teeth of another row of teeth.

12. The vial of claim 1, wherein said container includes opposed gripping handles.

13. The vial of claim 12, wherein said handles are arcuate.

14. The vial of claim 1, wherein said piercing member comprises a multi-sided pintel.

15. The vial of claim 1, wherein said chamber contains a tooth whitening gel.

16. The vial of claim 1, wherein said container is made of soft plastic.

17. An improved dispensing vial, comprising:
a) a resilient container having an internal chamber and an elongated neck terminating at an outlet, said outlet being sealed by a frangible sealing element, whereby contents of said internal chamber are hermetically sealed;
b) an applicator mounted above said outlet and including a central passageway terminating remote from said container at a comb-like applicator structure comprising two arcuate rows of teeth to either side of said central passageway;
c) a cap mounted over said applicator, said cap having a piercing member extending toward said frangible sealing element, said cap being movable between a first position in which said piercing member is spaced from said frangible sealing element and a second position in which said piercing member pierces said frangible sealing element; and
d) a limit stop on said applicator having a first position in which said piercing member is precluded from piercing said frangible sealing element and a second position in which said cap is permitted to move to said second position of said cap to cause said piercing member to pierce said frangible sealing element.

18. The vial of claim 17, wherein said frangible sealing element comprises a foil seal.

19. The vial of claim 17, wherein said limit stop has a top surface, said cap having a bottom surface resting on said top surface of said limit stop in said first position of said limit stop and wherein said second position of said limit stop comprises said limit stop being removed from said applicator.

20. The vial of claim 17, wherein one row of teeth has longer teeth than the teeth of another row of teeth.
